(19) United States
(12) Patent Application Publication
(10) Pub. No.: US 2022/0335300 A1
(43) Pub. Date: Oct. 20, 2022

(54) Using Graph Structures to Represent Node State in Deep Reinforcement Learning (RL)-Based Decision Tree Construction

(71) Applicant: VMware, Inc., Palo Alto, CA (US)

(72) Inventors: Yaniv Ben-Itzhak, Afek (IL); Shay Vargaftik, Nazareth-Illit (IL); Ayal Taitler, Haifa (IL)

(21) Appl. No.: 17/231,476

(22) Filed: Apr. 15, 2021

(51) Int. Cl. G06N 3/08; G06N 5/00; G06F 16/901

(52) U.S. Cl. CPC G06N 3/084; G06N 5/003; G06F 16/9024

(57) ABSTRACT

In one set of embodiments, a deep reinforcement learning (RL) system can train an agent to construct an efficient decision tree for classifying network packets according to a rule set, where the training includes: identifying, by an environment of the deep RL system, a leaf node in a decision tree; computing, by the environment, a graph structure representing a state of the leaf node, the graph structure including information regarding how one or more rules in the rule set that are contained in the leaf node are distributed in a hypercube of the leaf node; communicating, by the environment, the graph structure to the agent; providing, by the agent, the graph structure as input to a graph neural network; and generating, by the graph neural network based on the graph structure, an action to be taken on the leaf node for extending the decision tree.

### BACKGROUND

Packet classification is a task commonly performed by network devices such as switches and routers that comprises matching a network packet to a rule in a list of rules, referred to as a rule set. Upon matching a network packet to a particular rule, a network device can carry out an associated action (e.g., drop, pass, redirect, etc.) on the network packet, which enables various features/services such as flow routing, QoS (Quality of Service), access control, and so on.

Software-based solutions for implementing packet classification generally involve constructing a decision tree that encodes sequences of decisions usable for matching network packets to rules in a rule set. However, algorithmically constructing decision trees that are efficient in terms of memory usage, classification time, and/or other metrics is difficult. According to one approach, deep reinforcement learning (RL)—which is a machine learning paradigm concerned with training a neural network-based agent to take actions in an environment to maximize some reward—can be leveraged to facilitate the construction of efficient decision trees. Unfortunately, conventional implementations of this approach suffer from a number of drawbacks such as lack of agent generality, long training times, and more.

### BRIEF DESCRIPTION OF THE DRAWINGS

FIG. 1 depicts a first deep RL system.

FIGS. 2A and 2B depict example packet classification decision trees.

FIG. 3 depicts a second deep RL system according to certain embodiments.

FIG. 4 depicts a flowchart for executing a rollout according to certain embodiments.

FIG. 5 depicts grid-based graph structure type according to certain embodiments.

FIG. 6 depicts a range trees-based graph structure type according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof

### 1. Overview

The present disclosure is directed to improved techniques for implementing deep RL-based construction of decision trees for packet classification and other similar applications. In one set of embodiments, these improved techniques include (1) using a graph structure to represent the state of a decision tree node that is communicated from an environment to an agent, where the graph structure includes information indicating how the rules at that node are distributed within a hypercube of the node (explained below), and (2) using a graph neural network, rather than a standard neural network, in the agent to process the received node states and generate tree building actions. With (1) and (2), the agent can be trained to construct efficient decision trees in a manner that is more generalizable, performant, and effective than existing deep RL-based solutions.

### 2. Conventional Deep RL System and High-Level Solution Description

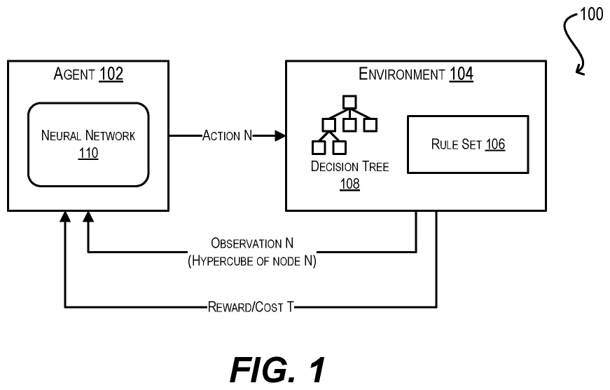

FIG. 1 depicts a conventional deep RL system 100 that is designed to train an agent 102, via interaction with an environment 104, to construct an efficient decision tree for classifying network packets according to a rule set 106. Each rule in rule set 106 includes a priority value and five matching patterns that correspond to the network packet header fields “source address,” “destination address,” “source port,” “destination port,” and “protocol” respectively. For example, the following are three sample rules that may be part of rule set 106:

TABLE 1

| Rule | | | Destination | | | |
|---|---|---|---|---|---|---|
| ID | Priority | Source Address | Address | Source Port | Destination Port | Protocol |
| R1 | 0 | * | * | * | [0,1000] | * |
| R2 | 1 | 100.0.0.0/16 | 100.0.0.0/16 | [1001, 2000] | [1001, 2000] | * |
| R3 | 2 | 100.0.0.0/16 | 100.0.0.0/16 | [0, 1000] | [2001, 65535] | TCP |

The task of classifying network packets according to rule set 106 comprises matching the network packets to specific rules in rule set 106, where a network packet P is deemed to match a rule R if the values for the source address, destination address, source port, destination port, and protocol fields in packet P's header satisfies the corresponding matching patterns included in rule R. In the case where network packet P matches multiple rules in rule set 106, the highest priority rule among those multiple rules is chosen.

Another way to conceptualize this packet classification task is to visualize each rule in rule set 106 as a closed, convex geometric shape, referred to as a hypercube, that resides in a 5-dimensional (5D) space S whose five dimensions correspond to the rule fields source address, destination address, source port, destination port, and protocol, and to visualize each network packet as a point or a hypercube in 5D space S defined by the packet's header values for these five fields. The boundaries of the hypercube for each rule are defined by the per-field matching patterns included in the rule. With these visualizations in mind, a network packet P is deemed to match a rule R if the point representation of P in 5D space S lies within the hypercube of rule R. In the case where the point representation of P lies within the hypercubes of multiple rules, the highest priority rule is chosen as noted above.

One common process for building a decision tree that is capable of classifying network packets according to a rule set such as rule set 106 involves: (1) establishing a root node that contains all of the rules in the rule set, (2) starting with the root node, recursively splitting the nodes in the decision tree along one or more of the rule fields (i.e., dimensions), resulting in new leaf nodes that each contains some subset of the rules of its parent node, and (3) repeating step (2) until each leaf node contains fewer than a predefined number of rules. The rules that are contained at each node N of the decision tree can be understood as the rules whose hypercubes intersect a hypercube of node N in 5D space S, where the boundaries of node N's hypercube are defined by the split conditions used to reach node N from the root node. For example, in a decision tree T with a root node N1 and a child node N2 that is split from root node N1 via the split condition “source port<1000,” the hypercube of node N2 would encompass all of the space in 5D space S where the value for source port is less than 1000. Once the decision tree is built, an incoming network packet can be classified in accordance with the decision tree's rule set by traversing the decision tree from the root node to a leaf node based on the network packet's<source address, destination address, source port, destination port, protocol>values and choosing the highest priority rule at the leaf node that matches the packet.

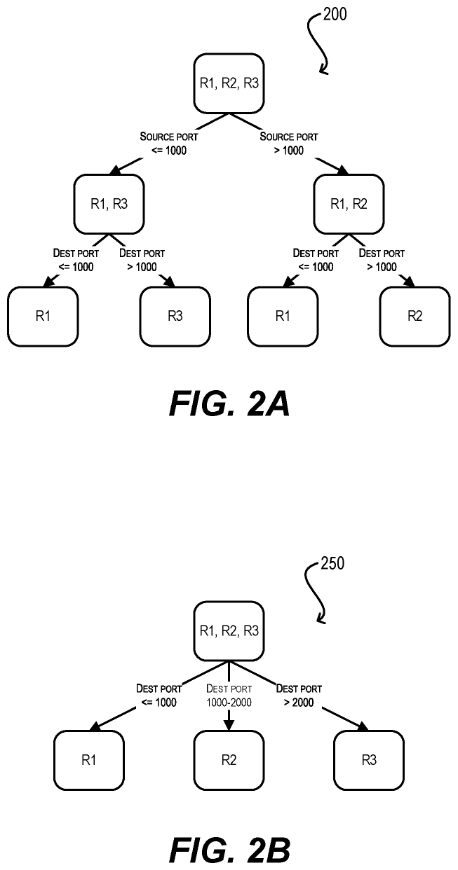

However, as mentioned in the Background section, algorithmically building efficient packet classification decision trees is a difficult endeavor, largely because it is possible to build many valid decision trees for a given rule set, each with different characteristics in terms of tree size/height, classification latency, and so on. For instance, FIGS. 2A and 2B depict two different decision trees 200 and 250 that can classify network packets according to rules R1-R3 presented in Table 1 above. Accordingly, deep RL system 100 of FIG. 1 is designed to train agent 102 such that, from among the universe of valid decision trees for rule set 106, agent 102 is able to construct a decision tree that is optimal (or close to optimal) with respect to a desired efficiency metric or combination of metrics.

To achieve this, environment 104 of system 100 maintains the state of an “in-progress’ decision tree 108 (i.e., a decision tree that is in the process of being constructed, starting from its root node) and communicates the state of each leaf node N of decision tree 108 (shown in FIG. 1 as “observation N”) to agent 102. This node state/observation identifies the boundaries of the hypercube of node N, which as indicated previously is a closed, convex shape in 5D space S that is defined by the split conditions taken to reach the node in the decision tree.

Upon receiving this node state, agent 102 provides the node state as input to a standard (i.e., non-graph) neural network 110, which in turn generates/outputs an action to perform on leaf node N (shown in FIG. 1 as “action N”), such as splitting the node into two or more child nodes, and communicates the action to environment 104. Environment 104 then applies the action to in-progress decision tree 108 (thereby “building out” the tree), and the foregoing steps are repeated until, e.g., each leaf node contains fewer than a predefined number of rules (resulting in a fully-built version of decision tree 108).

Upon completing the construction of decision tree 108, environment 104 calculates a reward or cost for the tree based on one or more efficiency metrics (e.g., tree size/height, classification latency, etc.) and transmits the reward/cost to agent 102 (shown in FIG. 1 as “reward/cost T”). In response, agent 102 updates the weights/parameters of neural network 110 based on the reward/cost, thereby training neural network 110 towards maximizing the reward (or minimizing the cost). Finally, this decision tree building process (also known as a “rollout”) is iterated many times, resulting in the creation of many decision trees 108 and many updates to neural network 110, until agent 102 is deemed to be sufficiently trained and thus capable of generating an efficient final decision tree for rule set 106.

Unfortunately, while the overall training procedure described above is functional, it also suffers from a number of notable drawbacks. For example, because environment 104 uses a single hypercube to represent the state of each leaf node N that is communicated to agent 102, agent 102 and its neural network 110 do not have visibility into how the rules at that node are internally distributed within the node's hypercube and thus cannot learn how to split the node in an intelligent and generic way based on those rule distributions. Instead, agent 102/neural network 110 can only learn how to split the node based on the boundaries of the node's hypercube, which can provide good results for rule set 106 (i.e., the specific rule set used to drive the training), but generally provides poor results for other, different rule sets. Stated another way, trained agent 102 lacks generality with this approach. As a consequence, if rule set 106 is modified or replaced with a new rule set (which can occur often in network environments), system 100 must re-train agent 102 from scratch in order to construct an efficient decision tree for the new/modified rule set.

Further, agent 102's lack of visibility into the rule distributions at each decision tree node typically leads to long training times. For instance, thousands of rollouts or more may be needed before neural network 110 converges and a reasonably efficient final decision tree for rule set 106 is achieved. These long training times are exacerbated by the lack of generality noted above, which necessitates frequent re-training of agent 102.

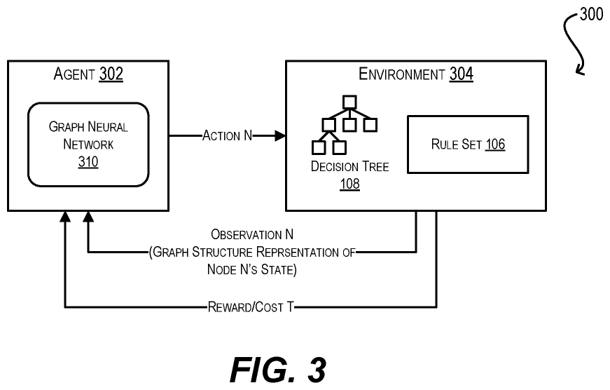

To address the foregoing and other similar problems, FIG. 3 depicts a modified version of deep RL system 100 (i.e., deep RL system 300) that includes an enhanced agent 302 comprising a graph neural network 310 and an enhanced environment 304 according to embodiments of the present disclosure. As used herein, a graph neural network is a type of neural network that can accept as input a graph structure that varies in size. This is in contrast to standard neural network 110 of FIG. 1 which can only accept as input fixed-size data (e.g., a fixed-size vector).

At a high level, at the time of communicating the state of a leaf node N of decision tree 108 to agent 302, environment 304 can compute and transmit a graph structure representation of that node state to agent 302, where this graph structure encodes information regarding how the rules contained at node N (or more precisely, how the hypercubes of those rules) are distributed/placed within the hypercube of node N. This is a more informative node state representation than the one employed by system 100 of FIG. 1 because it allows agent 302 to understand the inner rule structure of node N's hypercube, rather than simply its outer boundaries.

Then, upon receiving this graph structure representation of node N's state from environment 304, agent 302 can provide the graph structure as input (subject to one or more transformation/convolution functions) to graph neural network 310. This is possible because graph neural network 310 is designed to accept variable-sized graph structures as input. Graph neural network 310 can thereafter generate/output an action to be taken on node N based on the graph structure and the remaining training steps can be carried out in a manner similar to deep RL system 100 of FIG. 1.

With the architecture/approach shown in FIG. 3 and described above, a number of advantages are realized. First, because environment 304 provides to agent 302 a graph structure representation of each leaf node state of decision tree 108 that includes information regarding rule distributions within the node's hypercube (rather than simply the boundaries of that hypercube), agent 302 and graph neural network 310 can specifically learn how to split each node based on that rule distribution information. Thus, the trained version of agent 302 can understand how the per-node rule distributions affect optimal decision tree construction, which makes the agent generalizable (i.e., useful for building decision trees for different rule sets).

Second, because the graph structure representation of node states used in system 300 is more informative that the single hypercube representation used in system 100, graph neural network 310 can converge faster than its counterpart in system 100, leading to reduced training times and in some cases more efficient final decision trees.

Third, the approach implemented by system 300 allows for significant information flexibility in terms of the types of graph structures used to represent node state, which in turn allows for different tradeoffs between graph size complexity and degree of informativeness. To illustrate this, section (4) below describes three different types of graph structures that may be employed in system 300 and that sit at different points along the size complexity/informativeness spectrum.

It should be appreciated that deep RL system 300 of FIG. 3 is illustrative and not intended to limit embodiments of the present disclosure. For example, while agent 302 and environment 304 are shown as separate entities which may run on, e.g., separate physical/virtual machines, in some embodiments agent 302 and environment 304 may be implemented as a single entity that runs on the same physical/virtual machine.

In addition, while the foregoing description focuses on the notion of constructing efficient decision trees for packet classification, deep RL system 300 can also be used to construct efficient decision trees for other use cases/applications in which such functionality would be desired or needed. For these alternative use cases/applications, the nature of rule set 106 (e.g., types of rule fields/dimensions, number of rule fields/dimensions, etc.) may differ, but the overall training process can be retained. One of ordinary skill in the art will recognize other variations, modifications, and alternatives.

### 3. Single Rollout Workflow

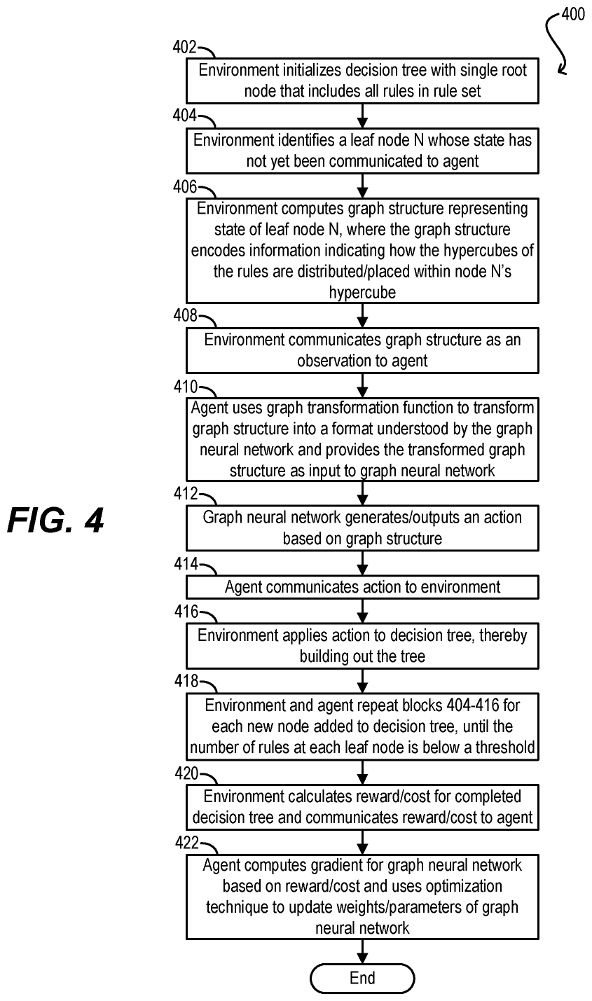

FIG. 4 is a flowchart 400 that details the steps that may be performed by agent 302 and environment 304 of FIG. 3 for executing a single rollout (or in other words, constructing a single decision tree 108) with respect to rule set 106 according to certain embodiments.

Starting with blocks 402 and 404, environment 304 can initialize decision tree 108 with a single root node that includes all of the rules in rule set 106 and can identify a leaf node N in decision tree 108 whose node state has not yet been communicated to agent 302. In the initial case where decision tree comprises a single root node, environment 304 can identify the root node as a leaf node for the purposes of block 404.

At block 406, environment 304 can compute a graph structure for representing the state of leaf node N, where this graph structure encodes information regarding how the hypercubes of the rules contained at leaf node N are distributed or placed within the node's hypercube. As mentioned previously, the hypercube of a rule is a closed, convex shape in a multi-dimensional (e.g., 5D) space whose boundaries are defined by the matching patterns specified in the rule. Further, the hypercube of a node is a closed, convex shape in that same multi-dimensional space whose boundaries are defined by the split conditions used to reach the node from the root node of the node's decision tree. There are many different types of graph structures that can be used for representing node state which exhibit different tradeoffs in terms of size complexity and informativeness (i.e., the amount of information the graph structure conveys regarding the inner structure of the node's hypercube); three example types are discussed in section (4) below.

Upon computing the graph structure representing the state of leaf node N, environment 304 can communicate this graph structure as an observation to agent 302 (block 408). In response, agent 302 can transform the graph structure into a format understood by graph neural network 310 and provide the transformed graph structure as input to network 310 (block 410). In one embodiment, agent 302 can use a graph convolution function to perform this transformation of the graph structure. In other embodiments, agent 302 can use any graph transformation function known in the art.

Graph neural network 310 can then generate/output an action based on the graph structure, where the action specifies an operation to be performed with respect to leaf node N that extends or “builds out” the decision tree at leaf node N (block 412). For example, in one set of embodiments this action can be an operation to split leaf node N into multiple child nodes in accordance with one or more split conditions defined along a rule field/dimension. The specific type of action that is generated and output by graph neural network 310 can vary depending on, e.g., the nature of the graph structure provided as input and potentially other factors. Agent 302 can thereafter communicate the action to environment 304 (block 414).

At block 416, environment 304 can apply the received action to decision tree 108, thereby building out the tree. For example, if the received action specifies a node split operation, environment 304 can split leaf node N into new child nodes per the split condition(s) specified in the action. As part of this step, environment 304 can update each new child node to contain the correct subset of rules from leaf node N in accordance with the split condition(s) and the matching patterns in the rules.

Environment 304 and agent 302 can subsequently repeat blocks 404-416 in a recursive manner for each new child node added to decision tree 108, and this can continue until the number of rules contained in every leaf node of decision tree 108 is below a predefined rule threshold (block 418).

Once this stopping condition is reached, environment 304 can consider the construction of decision tree 108 complete, calculate a reward (or cost) for decision tree 108 using an appropriate reward/cost function, and communicate this reward/cost to agent 302 (block 420).

Finally, at block 422, agent 302 can use backpropagation to compute a gradient for the layers of graph neural network 310 based on the reward/cost and apply an optimization technique (such as, e.g., stochastic gradient descent) to update the weights/parameters of graph neural network 310, thereby training the network towards maximizing the reward (or minimizing the cost). Although not shown in FIG. 4, if the reward/cost is within some predefined margin of a desired value, system 300 can halt the training of agent 302 at that point and use the last-created decision tree as the final decision tree for rule set 106. Otherwise, system 300 can move on to executing the next rollout.

It should be appreciated that flowchart 400 is illustrative and various modifications are possible. For example, although the steps of flowchart 400 are shown as being executed sequentially, in certain embodiments blocks 404-416 can be performed in parallel for independent nodes of decision tree 108.

### 4. Graph Structure Types

As mentioned previously, there are many types of graph structures that can be used to represent the state of a decision tree node in a way that provides information regarding how the rules at the node are distributed within the node's hypercube. The following sub-sections describe three such graph structure types that offer different tradeoffs in terms of size complexity and informativeness.

### 4.1 Grid Type

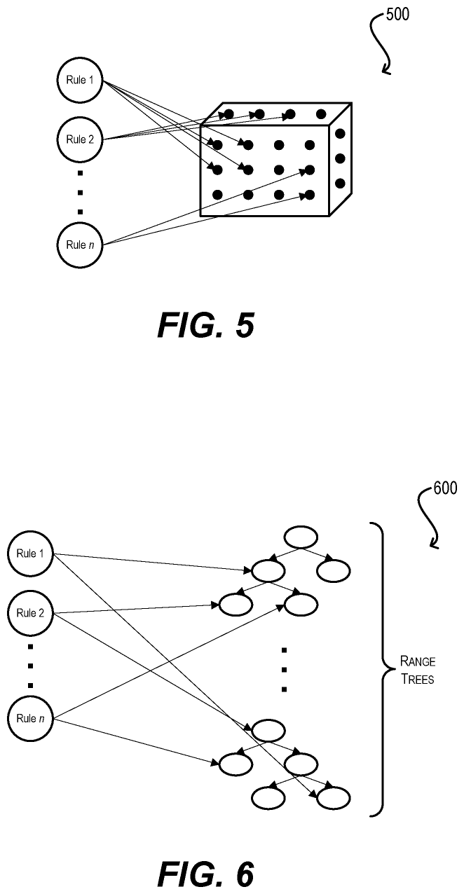

With this graph structure type, the state of a given decision tree node N is represented as a bipartite graph G_{grid}, where one side of G_{grid} comprises the rules for which the decision tree is built and the other side of G_{grid} comprises a multi-dimensional (e.g., 5D) grid of points corresponding to the hypercube of node N (or alternatively, the convex hull of all of the rule hypercubes residing within the node's hypercube). A schematic example of G_{grid} is shown via reference numeral 500 in FIG. 5.

Each edge in bipartite graph G_{grid} between a rule R and a point P in the grid indicates that point P lies within the hypercube of rule R (or in other words, point P matches rule R). Thus, bipartite graph G_{grid} can provide a very granular and thus very informative view into how the rules are distributed within node N's hypercube, limited only by the density of points in the grid. Generally speaking, this grid can be generated using any of a number of different density methods and heuristics in order to obtain a desired level of coverage of the hypercube of node N.

Assuming that there are n rules and m grid points, the size complexity of this graph structure type is O(m·n).

### 4.2 Range Trees Type

With this graph structure type, the state of a given decision tree node N is represented as a bipartite graph G_{range}, where one side of G_{range} comprises the rules for which the decision tree is built and the other side of G_{range} comprises nodes from a plurality of range trees (one range tree for each rule dimension/field). A range tree is a tree data structure holding a set of 1-dimensional points that enables a binary search on those points. A schematic example of G_{range} is shown via reference numeral 600 in FIG. 6.

In one set of embodiments, each range tree in the plurality of range trees (corresponding to a particular rule dimension D) can be built in the following manner: (1) a root node is created that contains the entire range of values along dimension D in node N's hypercube, (2) the root node is split into two leaf nodes, each containing half of the range in the parent (root) node (or alternatively, a range that includes approximately half of the rules), and (3) the foregoing steps are repeated recursively on each leaf node created at step (2) until the number of rules contained in every leaf node is sufficiently small (or a predefined tree size limit is reached). Once the range trees are built, each rule in bipartite graph G_{range} is connected to a node in each range tree that contains the smallest range which falls within the corresponding matching pattern of the rule (referred to as the “minimal range”). Thus, G_{range} effectively defines an over-sized hypercube for each rule that bounds where that rule's true hypercube lies within the hypercube of node N, which provides a moderately informative view into how the rules are distributed.

Assuming that there are n rules and m nodes across all range trees, the size complexity of this graph structure type is O(n+m).

### 4.3 Heat Map Type

This graph structure type employs the same range trees used for the range trees type; however, rather than defining a bipartite graph linking rules to range tree nodes, this type records, at each node of each range tree containing a minimal range for the tree's dimension, the number of rules matching that minimal range. This turns the range trees into a heat map that reflects the spatial density of rules at those ranges, which provides a less informative, but still helpful, view into how the rules are distributed.

Assuming that there are n rules and m nodes across all range trees, the size complexity of this graph structure type is O(m).

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any data storage device that can store data which can thereafter be input to a computer system. The non-transitory computer readable media may be based on any existing or subsequently developed technology for embodying computer programs in a manner that enables them to be read by a computer system. Examples of non-transitory computer readable media include a hard drive, network attached storage (NAS), read-only memory, random-access memory, flash-based nonvolatile memory (e.g., a flash memory card or a solid state disk), a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
training, by a deep reinforcement learning (RL) system, an agent to construct an efficient decision tree for classifying network packets according to a rule set comprising a plurality of rules, the training including:
identifying, by an environment of the deep RL system, a leaf node in a decision tree;
computing, by the environment, a graph structure representing a state of the leaf node, wherein the graph structure includes information regarding how one or more rules in the rule set that are contained in the leaf node are distributed in a hypercube of the leaf node, wherein the hypercube is a convex shape in a multi-dimensional space having dimensions corresponding to rule fields in the rule set, and wherein the hypercube's boundaries are defined by split conditions used to reach the leaf node in the decision tree;
communicating, by the environment, the graph structure to the agent;
providing, by the agent, the graph structure as input to a graph neural network, the graph neural network being designed to accept variable-sized graph structures as input; and
generating, by the graph neural network based on the graph structure, an action to be taken on the leaf node for extending the decision tree.

2. The method of claim 1 wherein the information regarding how the one or more rules contained in the leaf node are distributed in the hypercube of the leaf node comprises, for each of the one or more rules, information regarding how a hypercube of said each rule is placed in the hypercube of the leaf node, the hypercube of said each rule being a convex shape in the multi-dimensional space having boundaries defined by matching patterns included in said each rule.

3. The method of claim 1 wherein providing, by the agent, the graph structure as input to a graph neural network comprises:
transforming, by the agent, the graph structure using a graph transformation function; and
providing, by the agent, the transformed graph structure as input to the graph neural network.

4. The method of claim 1 wherein the action splits the leaf node into a plurality of child nodes in accordance with one or more split conditions defined along one of the rule fields.

5. The method of claim 1 wherein the graph structure is a bipartite graph comprising first and second sides, wherein the first side includes a plurality of graph nodes corresponding the plurality of rules, wherein the second side includes a grid of points in the hypercube of the leaf node, and wherein the bipartite graph includes an edge between a graph node in the plurality of graph nodes and a point in the grid of points if the point lies within a hypercube of the rule corresponding to the graph node.

6. The method of claim 1 wherein the graph structure is a bipartite graph comprising first and second sides, wherein the first side includes a plurality of graph nodes corresponding the plurality of rules, wherein the second side includes a plurality of range trees corresponding to the rule fields of the rule set, and wherein the bipartite graph includes an edge between a graph node in the plurality of graph nodes and a node in a range tree corresponding to a rule field R if a matching pattern specified for rule field R in the rule corresponding to the graph node falls within a value range associated with the node.

7. The method of claim 1 wherein the graph structure comprises a plurality of range trees corresponding to the rule fields of the rule set, and wherein at least one node of at least one range tree includes a number of rules in the rule set that match a value range associated with the node.

8. A non-transitory computer readable storage medium having stored thereon program code executable by a computer system implementing a deep reinforcement learning (RL) system, the program code causing the computer system to execute a method comprising:
training an agent to construct an efficient decision tree for classifying network packets according to a rule set comprising a plurality of rules, the training including:
identifying, by an environment of the deep RL system, a leaf node in a decision tree;
computing, by the environment, a graph structure representing a state of the leaf node, wherein the graph structure includes information regarding how one or more rules in the rule set that are contained in the leaf node are distributed in a hypercube of the leaf node, wherein the hypercube is a convex shape in a multi-dimensional space having dimensions corresponding to rule fields in the rule set, and wherein the hypercube's boundaries are defined by split conditions used to reach the leaf node in the decision tree;
communicating, by the environment, the graph structure to the agent;
providing, by the agent, the graph structure as input to a graph neural network, the graph neural network being designed to accept variable-sized graph structures as input; and
generating, by the graph neural network based on the graph structure, an action to be taken on the leaf node for extending the decision tree.

9. The non-transitory computer readable storage medium of claim 8 wherein the information regarding how the one or more rules contained in the leaf node are distributed in the hypercube of the leaf node comprises, for each of the one or more rules, information regarding how a hypercube of said each rule is placed in the hypercube of the leaf node, the hypercube of said each rule being a convex shape in the multi-dimensional space having boundaries defined by matching patterns included in said each rule.

10. The non-transitory computer readable storage medium of claim 8 wherein providing, by the agent, the graph structure as input to a graph neural network comprises:
transforming, by the agent, the graph structure using a graph transformation function; and
providing, by the agent, the transformed graph structure as input to the graph neural network.

11. The non-transitory computer readable storage medium of claim 8 wherein the action splits the leaf node into a plurality of child nodes in accordance with one or more split conditions defined along one of the rule fields.

12. The non-transitory computer readable storage medium of claim 8 wherein the graph structure is a bipartite graph comprising first and second sides, wherein the first side includes a plurality of graph nodes corresponding the plurality of rules, wherein the second side includes a grid of points in the hypercube of the leaf node, and wherein the bipartite graph includes an edge between a graph node in the plurality of graph nodes and a point in the grid of points if the point lies within a hypercube of the rule corresponding to the graph node.

13. The non-transitory computer readable storage medium of claim 8 wherein the graph structure is a bipartite graph comprising first and second sides, wherein the first side includes a plurality of graph nodes corresponding the plurality of rules, wherein the second side includes a plurality of range trees corresponding to the rule fields of the rule set, and wherein the bipartite graph includes an edge between a graph node in the plurality of graph nodes and a node in a range tree corresponding to a rule field R if a matching pattern specified for rule field R in the rule corresponding to the graph node falls within a value range associated with the node.

14. The non-transitory computer readable storage medium of claim 8 wherein the graph structure comprises a plurality of range trees corresponding to the rule fields of the rule set, and wherein at least one node of at least one range tree includes a number of rules in the rule set that match a value range associated with the node.

15. A computer system implementing a deep reinforcement learning (RL) system, comprising:
a processor; and
a non-transitory computer readable medium having stored thereon program code that, when executed, causes the processor to:
train an agent to construct an efficient decision tree for classifying network packets according to a rule set comprising a plurality of rules, the training including:
identifying, by an environment of the deep RL system, a leaf node in a decision tree;
computing, by the environment, a graph structure representing a state of the leaf node, wherein the graph structure includes information regarding how one or more rules in the rule set that are contained in the leaf node are distributed in a hypercube of the leaf node, wherein the hypercube is a convex shape in a multi-dimensional space having dimensions corresponding to rule fields in the rule set, and wherein the hypercube's boundaries are defined by split conditions used to reach the leaf node in the decision tree;
communicating, by the environment, the graph structure to the agent;
providing, by the agent, the graph structure as input to a graph neural network, the graph neural network being designed to accept variable-sized graph structures as input; and
generating, by the graph neural network based on the graph structure, an action to be taken on the leaf node for extending the decision tree.

16. The computer system of claim 15 wherein the information regarding how the one or more rules contained in the leaf node are distributed in the hypercube of the leaf node comprises, for each of the one or more rules, information regarding how a hypercube of said each rule is placed in the hypercube of the leaf node, the hypercube of said each rule being a convex shape in the multi-dimensional space having boundaries defined by matching patterns included in said each rule.

17. The computer system of claim 15 wherein providing, by the agent, the graph structure as input to a graph neural network comprises:
transforming, by the agent, the graph structure using a graph transformation function; and
providing, by the agent, the transformed graph structure as input to the graph neural network.

18. The computer system of claim 15 wherein the action splits the leaf node into a plurality of child nodes in accordance with one or more split conditions defined along one of the rule fields.

19. The computer system of claim 15 wherein the graph structure is a bipartite graph comprising first and second sides, wherein the first side includes a plurality of graph nodes corresponding the plurality of rules, wherein the second side includes a grid of points in the hypercube of the leaf node, and wherein the bipartite graph includes an edge between a graph node in the plurality of graph nodes and a point in the grid of points if the point lies within a hypercube of the rule corresponding to the graph node.

20. The computer system of claim 15 wherein the graph structure is a bipartite graph comprising first and second sides, wherein the first side includes a plurality of graph nodes corresponding the plurality of rules, wherein the second side includes a plurality of range trees corresponding to the rule fields of the rule set, and wherein the bipartite graph includes an edge between a graph node in the plurality of graph nodes and a node in a range tree corresponding to a rule field R if a matching pattern specified for rule field R in the rule corresponding to the graph node falls within a value range associated with the node.

21. The computer system of claim 15 wherein the graph structure comprises a plurality of range trees corresponding to the rule fields of the rule set, and wherein at least one node of at least one range tree includes a number of rules in the rule set that match a value range associated with the node.
